(19) United States
(12) Patent Application Publication
(10) Pub. No.: US 2012/0261022 A1
(43) Pub. Date: Oct. 18, 2012

(54) THERMAL ISOLATION, SUITABLE FOR ISOLATING THE GAS DISCHARGE TUBE OF A REFRIGERATING COMPRESSOR, AND A PROCESS OF ASSEMBLING THE ISOLATION IN THE GAS DISCHARGE TUBE

(75) Inventors: Fernando Antonio Ribas Junior, Joinville, SC (US); Rodrigo Link, Joinville, SC (US); Dietmar Erich Bernhard Lilie, Joinville, SC (US); Bruno Eduardo Da Silva, Joinville, SC (US)

(73) Assignee: WHIRLPOOL S.A., São Paulo, SP (BR)

(21) Appl. No.: 13/496,813

(22) PCT Filed: Sep. 13, 2010
(86) PCT No.: PCT/BR10/00306

§ 371 Date: Jul. 2, 2012

(30) Foreign Application Priority Data
Sep. 16, 2009 (BR) PI0903515-0

(51) Int. Cl. F16L 9/14; B23P 11/00

(52) U.S. Cl. 138/147; 29/428

(57) ABSTRACT

The present invention relates to a thermal isolation, suitable for isolating the gas discharge tube (13) of a refrigerating compressor (1), where the discharge tube (13) is arranged inside an isolating tube (14), forming at least a confined space between said tubes, the novelty basically consisting in that the isolating tube (14) comprises covers (15, 17) spaced apart, the cross section of the isolating tube (14) being formed by joining together the cross sections of the spaced apart covers (15, 17). In the preferred embodiment of the invention, the isolating tube (14) comprises multiple spacers, preferably annular spacers (16), arranged around the gas discharge tube (13 and the isolating tube (14), the isolating tube (14) consisting of a number tube portions (20, 26) joined together along the extension of the gas discharge tube (13). The invention also relates to a process for assembling the thermal isolation in the gas discharge tube.

### FIELD OF THE INVENTION

The present invention relates to a thermal isolation suitable for isolating the gas discharge tube of a refrigerating compressor, where the discharge tube is arranged inside an isolating tube, forming a confined space between said tubes. The confined space may be evacuated or provide air or another gas in its inside.

### BACKGROUND OF THE INVENTION

As is generally known, to increase the performance of refrigerating compressors, it is necessary to reduce the thermal losses that largely originate from heating the suction gas along its path inside the compressor, from its entry in the housing to the compressor cylinder.

In addition to the concern with performance, the reduction of the inner temperature of the components increases the life of the compressor, since it reduces the wear of the bearings and the degradation of other non-metallic components, such as rubbers and polymers.

It has been verified that the increase in the temperature of the suction gas and the inner components of the compressor is caused by heat sources located inside the compressor, one of the major heat sources being the compressed gas discharge tube.

An excellent alternative used to reduce the inner temperature of the compressor and avoid the problems mentioned above has been the thermal isolation of the discharge tube by means of the confined space concept. As is already known, the confined space concept consists in placing an isolating tube coaxially to the discharge tube, so that between the two tubes a space is formed where a gas is kept that does not move. There are also isolations where this space is evacuated, but this feature implies higher costs.

### PRIOR ART AND ITS DRAWBACKS

Thus, many types of isolation have been created by using this concept, the main obstacle to obtaining satisfactory results from the already known thermal isolations being the flexibility of said isolation, as an insufficiently flexible isolation makes its insertion in the tube to be isolated difficult. In addition, with an insufficiently flexible isolation, the vibrations from the operation of the compressor break said isolation.

In order to try to overcome this problem, documents U.S. Pat. No. 3,926,009 and U.S. Pat. No. 4,371,319 depict a thermal isolation by means of the confined space technique associated with corrugations, the discharge tube in document U.S. Pat. No. 3,926,009 being completely inserted inside a corrugated tube. However, the corrugated structure has the drawback that the corrugations act as if they were vanes, increasing the heat exchange area and, as a consequence, not providing a satisfactory thermal isolation for the discharge tube.

Another drawback is that the corrugated tubes have a higher manufacturing cost than the smooth tubes.

In addition, in isolation bent regions, the corrugated tubes fail to structurally keep a distance from the tube to be isolated, and, thus, they may lean on said tube, causing a thermal short circuit, which may decrease the isolation efficiency.

The great difficulty with isolating the discharge tubes is that they have many bends that are necessary to meet the design structure and vibration requirements. The usual isolation systems, even those mentioned in the prior patents, require the insertion of the isolating tube over the discharge tube, and this, for a tube with many bends, makes the process extremely expensive in terms of time, which affects productivity. The presence of many bends makes this process almost infeasible. Also, the discharge tube will undergo various processes during the compressor assembly, such as, for example, welding, and the presence of an isolating element in this moment would make the work even more difficult.

### OBJECTS AND ADVANTAGES OF THE INVENTION

It is the object of the present invention to provide a thermal isolation for the discharge tube of a refrigerating compressor that has optimal isolating properties, long durability and low cost.

This object is achieved by a thermal isolation, suitable for isolating the gas discharge tube of a refrigerating compressor, where the discharge tube is arranged inside an isolating tube, forming at least a confined space between said tubes. The isolating tube has a cross section peripherally closed and is made up by at least two covers joined together, the peripherally closed cross section being made up by joining together the cross sections of the at least two covers.

Although the preferred embodiment of the present invention is a isolating tube made up by two covers, it should be noted that the tube could be made up by a plurality of covers, the cross section of the tube corresponding to the joining together of the cross sections of the plurality of covers.

This solution proposed by the present invention facilitates the making and assembly of the isolating tube, since the covers may be molded and made separately and in parts, and the mounting in the discharge tube may be done by joining together these isolated parts.

In a preferred embodiment of the invention, the isolating tube also comprises multiple spacers, preferably annular spacers, arranged around the gas discharge tube and assuring a controlled spacing between the discharge tube and the isolating tube. The isolating tube may also consist of many portions of tube joined together along the extension of the gas discharge tube.

The isolating tube and the spacers may be, e.g., of metal or polymeric material (e.g., plastic) and the bend of the at least two covers may total 360°, forming a circular cross section for the tube. In this case, the isolating tube consists of two covers, the cross section of which has a bend of 180°.

The preferred solution utilizes a polymeric material (e.g., PBT or PEEK), as this material exhibits less mass and rigidity as compared to metal, a low thermal conductivity, in addition to a great flexibility of forms. Both the isolating tube and the spacers may be achieved, e.g., by means of an injection process.

Thus, one of the advantages of the thermal isolation according to the present invention is that the outer area of the isolating element is smaller than that of the corrugated tube of the prior art, improving the performance of said thermal isolation.

Another advantage of the present invention is that the covers of the isolating tube may be of injected plastic. Also, said tube is not necessarily required to be a closed tube, but to form an isolating envelope after is assembly.

Another important advantage of the invention is that the isolating tube may be made up by multiple parts injected in the form of a discharge to be isolated which may be, for example, fitted or glued together. In this manner, the isolating space would be a volume closed by components joined together.

Thus, the isolating tube according to the invention allows for the isolation not only of the tube itself, but those volumes that are inserted in the same. It is very common that the compressors exhibit discharge attenuating volumes welded to the gas discharge tube for the purpose of attenuating pulsation and the noise. The isolating tube according to the present invention allows the isolating covers of the tube and the attenuating volume to be injected, and the method of joining together said covers allows for the full isolation of the gas discharge system.

The amount of parts to be used will be determined by the tube geometry and the process of achieving them.

The isolation according to the present invention is not necessarily required to be hermetic, and it may exhibit leaks, common to a fitted structure. However, in case a hermetic solution is desired, and in the case the isolating covers are of a plastic material, the covers forming the isolating tube may be joined together, for example, by means of gluing, and in case the covers are of metal material, they may be joined together, for example, both by gluing and welding.

In case they are semi-hermetic, the parts may be fitted together only, resulting in another feature of the present invention: the spacers themselves, such as, for example, the annular spacers, may perform the function of jaws, also acting as an element for fitting the isolating structure with the discharge tube. These jaws may be present in two or more parts that close the isolating volume. In the case of two parts for closing the volume, it becomes easy to do it.

In addition, in the case of plastic parts, snap-on like fits may be provided on the edges of the parts to be fitted together, so as to create a fixing element, which increases the robustness of the fitting.

In the case of more parts along the axial direction of the tube (which may be required due to the bending planes thereof), the parts may also have fittings that connect a set of parts to others, assuring the closing of the volume.

In addition to all of the fitting elements shown, it is possible to join together the covers by means of, e.g., a metal ring or even a plastic strap, clip or another type of outer closing element of the two or more covers radially arranged, increasing the robustness of the thermal isolation.

Another advantage of the present invention, which makes it quite attractive as far as the increase in productivity in an assembly line is concerned, is that, in the case of a fitted isolating structure, the assembly of said structure (covers) could be one of the last steps of the production process. After all the mechanic kit, the discharge tube and the discharge volume (if any) have already been mounted in the housing, the isolating covers may be inserted, by press-fitting them, according to a design previously performed. The press-fitting assembly allows the process to be performed with the tube already mounted in the compressor, providing an advantage in the production process, considering the handling capability of said tube and the process of mounting it in the compressor (e.g., welding or screwing).

### BRIEF DESCRIPTION OF THE DRAWINGS

The invention will be described in further detail below, by way of example, based on the appended figures:

FIG. 1—an inner view of a refrigerating compressor, showing the discharge tube to be isolated with the thermal isolation according to the invention;

FIG. 2—an upper view of the compressor shown in FIG. 1;

FIG. 3—an inner view of a first cover of the isolating tube of the thermal isolation according to a first embodiment of the invention;

FIG. 4—an inner view of the gas discharge tube arranged inside the second cover of the isolating tube of the thermal isolation according to the first embodiment of the invention;

FIG. 5—an inner view of a refrigerating compressor, where the discharge volume and the gas discharge tube are isolated with the thermal isolation according to a second preferred embodiment of the invention;

FIG. 6—a sectional view of the thermal isolation of FIG. 5 and the discharge volume and the gas discharge tube removed from the compressor;

FIG. 7—a view of the discharge volume and a portion of the gas discharge tube of FIG. 6, isolated with the thermal isolation according to the invention; and

FIG. 8—an inner view of the discharge volume and the portion of the tube of FIG. 7 inside the thermal isolation according to the invention.

### DETAILED DESCRIPTION OF THE INVENTION

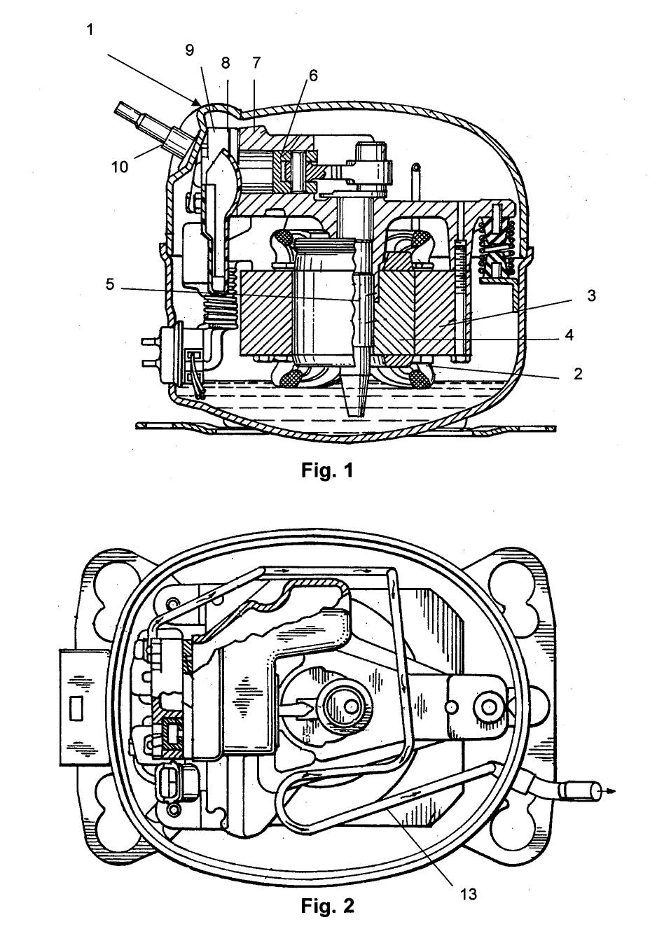

FIGS. 1 and 2 show a refrigerating compressor 1, where an electric motor 2 is seen, with a stator 3 and an armature 4. The motor shaft 5 drives a piston 6, arranged inside a cylinder 7 having a set of valves 8 and a head 9. At the bottom of the compressor is a lubricating oil reservoir. Thus, with the compressor in operation, the gas is sucked by suction line 10 into cylinder 7. Then, the gas is compressed by piston 6 and discharged by discharge tube 13, which will be isolated by a thermal isolation tube according to the present invention (it should be pointed out that FIGS. 1 and 2 do not show the isolation of the present invention). As is generally known, discharge tube 13 exhibits a long path inside the compressor, starting from cylinder 7 and extending towards the housing upper portion, so that the vibrations caused by the motor and the compression process are damped. Otherwise, if the length of the discharge tube between the cylinder and the wall of the compressor housing were short, said tube would rapidly break due to the extremely high wear tensions.

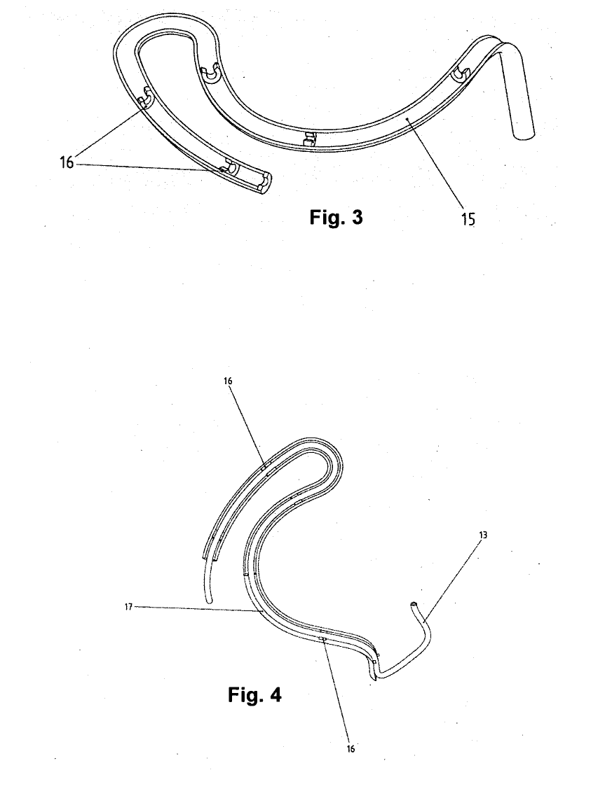

FIG. 3 shows an inner view of a first cover 15 of isolating tube 14 according to a preferred embodiment of the invention. As may be seen in the figure, cover 15 has a cross section with 180° of circumference. Thus, in this preferred embodiment of the invention, two covers are utilized with a circular cross section having a circumference of 180°, to form isolating tube 14, the cross section of which is a closed circumference (360°). The other cover 17 of the isolating tube of the thermal isolation according to the invention may be seen in FIG. 4.

Although FIGS. 3 and 4 show a preferred embodiment of the invention, wherein the tube is made up by two covers only, it is to be noted that more than two covers may be used, and in this case the joining together of the cross sections of the multiple covers would form the peripherally closed cross section of the tube.

In FIGS. 3 and 4 annular spacers 16 are seen. FIG. 3 shows the first half of annular spacers 16, and FIG. 4 shows the second half of annular spacers 16. Thus, by joining together first cover 15 and second cover 17, isolating tube 14 is formed with gas discharge tube 13 arranged in its inside and supported by annular spacers 16. Said annular spacers 16 keep gas discharge tube 13 away from the isolating tube 14 inner surface, at a constant annular distance, thus setting an even thickness for the confined space along the overall extension of the thermal isolation.

Between gas discharge tube 13 and each spacer 16 a small clearance may exist, so that a continuous confined space is formed between the isolating tube 14 inner surface and the gas discharge tube 13 outer surface. Alternatively, between gas discharge tube 13 and each spacer 16, a small interference may exist delimiting a number of hermetic chambers of confined spaces, isolated one from another.

FIG. 5 shows an inner view of a refrigerating compressor, where discharge volume 18 and gas discharge tube 13 are isolated with thermal isolation 19 according to a second embodiment of the invention.

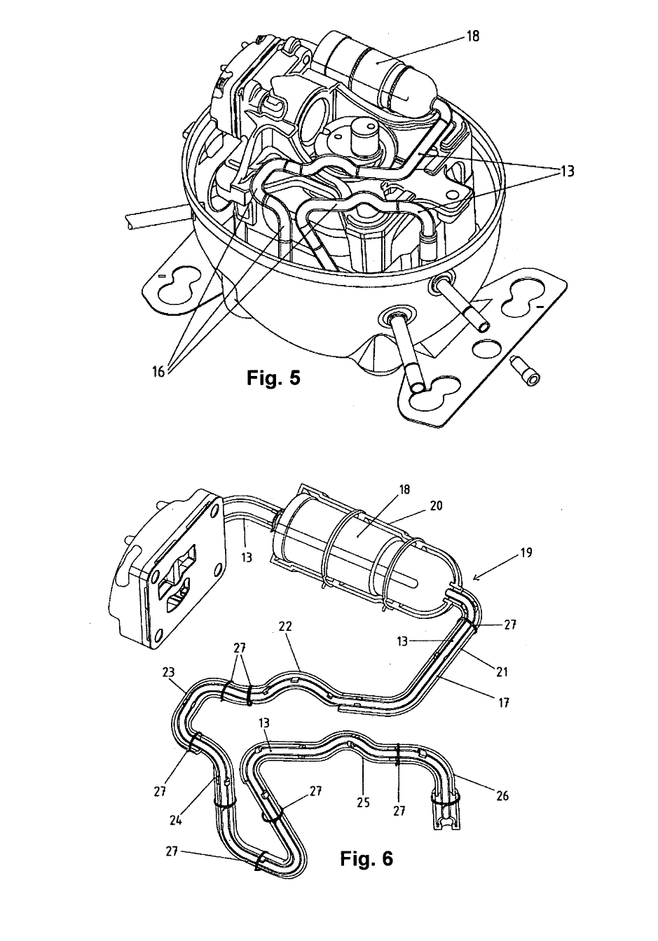

FIG. 6 shows a sectional view of thermal isolation 19 of FIG. 4 and discharge volume 18 and gas discharge tube 13 removed from the compressor. It may be seen in the figure that thermal isolation 19 is made up by multiple portions of tube 20 to 26 joined together along the extension of gas discharge tube 13. In the present embodiment, each portion of tube 20 to 26 is made up by two plastic covers 15 and 17 (only covers 17 are shown in the figure), preferably made by injection and joined together by means of brackets 27. Covers 15 and 17 could also be joined together by means, for example, of gluing or press-fitting annular spacers 17 onto discharge tube 13. The joining of each portion of tube 20 to 26 my be, for example, by means of gluing.

It should be pointed out that, although the preferred embodiment contemplates covers made of plastic material, any other type of suitable material may be used, such as, for example, other polymeric materials. In this sense, in an alternative embodiment of the present invention, covers 15 and 17 could be formed from a rubber having suitable properties.

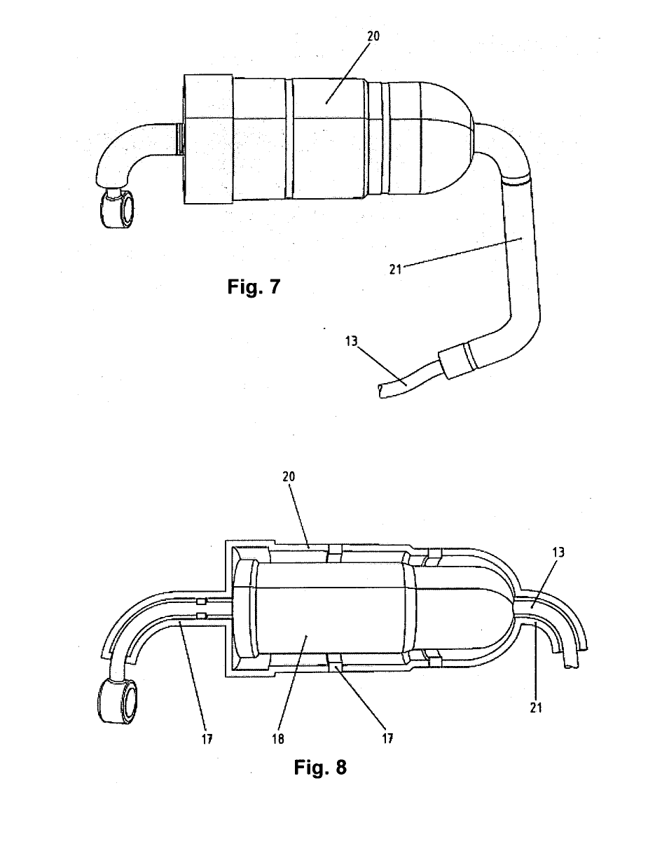

FIG. 7 shows a view of discharge volume 18 and a portion of gas discharge tube 13 of FIG. 5, isolated by portions 20 and 21 of thermal isolation 19 according to the second embodiment of the invention.

FIG. 8 shows an inner view of discharge volume 18 and the portions of isolating tube 20 and 21 shown in the figure. The figure shows only cover 17 of each portion of the isolating tube, since cover 15 has been removed to show discharge volume 18 and discharge tube 13 arranged inside the isolation.

Covers 15 and 17 may be of plastic and joined together, preferably hermetically, by gluing. Alternatively, the covers may be of metal and joined together, preferably hermetically, by welding. Naturally, in alternative embodiments of the present invention, any type of suitable joining means could be used, including brazing for metal covers and ultrasonic joining for plastic covers.

As for the isolating tube 14 assembly process, the covers may be joined to discharge tube 13 by press-fitting the annular spacers our by means of outer brackets. As already mentioned, where the two covers are made of plastic, they may joined together hermetically, e.g., by gluing; and where they are made of metal, such as, for example, steel or a copper alloy, welding may be used, for example, to join together said covers. In addition to the embodiment previously provided, the same inventive concept may be applied to other alternatives or possibilities of using the invention. For instance, the confined space may be evacuated, or the isolation may be used to isolated vapor nets.

As such, it will be appreciated that the present invention should be construed broadly, its scope being determined by the terms of the appended claims.

1. A thermal isolation of a gas discharge tube, suitable for isolating a gas discharge tube (13) of a refrigerating compressor (1), where the gas discharge tube (13) is arranged inside an isolating tube (14) having a peripherally closed cross section, forming at least a confined space between said tubes, CHARACTERIZED in that
the isolating tube (14) is made up by at least two covers (15, 17) joined together, the peripherally closed cross section being formed by joining together the cross sections of the at least two covers, and
the isolating tube (14) comprises multiple spacers (16) arranged around the gas discharge tube (13) and providing a controlled spacing between the discharge tube (13) and the isolating tube (14).

2. The thermal isolation, according to claim 1, CHARACTERIZED in that the isolating tube (14) is made up by a plurality of covers, and the peripherally closed cross section is formed by joining together the cross sections of the plurality of covers.

3. The thermal isolation, according to claim 1, CHARACTERIZED in that the peripherally closed cross section of the isolating tube (14) is a circular wall and the bends of the cross sections of the covers (15, 17) total 360°.

4. The thermal isolation, according to claim 1, CHARACTERIZED in that the spacers (16) are preferably annular and are joined to the gas discharge tube (13) with a small clearance, delimiting a continuous confined space.

5. The thermal isolation, according to claim 1, CHARACTERIZED in that the spacers (16) are joined to the gas discharge tube (13) with an interference, delimiting a number of hermetic chambers of confined spaces isolated one from another.

6. The thermal isolation, according to claim 1, CHARACTERIZED in that the isolating tube (14) and its respective spacers (16) are made of a polymeric material.

7. The thermal isolation, according to claim 1, CHARACTERIZED in that the isolating tube (14) and its respective spacers (16) are made of metal.

8. The thermal isolation, according to any of claim 1, CHARACTERIZED in that the isolating tube (14) and its respective spacers (16) are made of rubber.

9. The thermal isolation, according to claim 1, CHARACTERIZED in that the isolating tube (14) consists of a number of tube portions (20 to 26) joined together along the extension of the gas discharge tube (13).

10. The thermal isolation, according to any of claim 1, CHARACTERIZED in that the covers (15, 17) are made of plastic and are joined together, preferably hermetically, by gluing or ultra-sonic joining.

11. The thermal isolation, according to claim 1, CHARACTERIZED in that the covers (15, 17) are made of metal and are joined together, preferably hermetically, by welding or brazing.

12. A process of assembling a thermal isolation of a gas discharge tube, suitable for isolating a gas discharge tube (13) of a refrigerating compressor (1), where the gas discharge tube (13) is arranged inside an isolating tube (14) having a peripherally closed cross section, forming at least a confined space between said tubes, CHARACTERIZED by the fact that it involves the following steps:
arranging the gas discharge tube (13) inside the isolating tube (14) by at least two covers (15, 17) and spacers (16), and
joining the at least two covers (15, 17) to the discharge tube (13) by means of outer brackets (27).

13. A process according to claim 12, CHARACTERIZED in that the covers (15, 17) are joined to the discharge tube (13) by press-fitting the annular spacers (16).

14. The thermal isolation, according to claim 2, CHARACTERIZED in that the peripherally closed cross section of the isolating tube (14) is a circular wall and the bends of the cross sections of the covers (15, 17) total 360°.

15. The thermal isolation, according to claim 4, CHARACTERIZED in that the spacers (16) are joined to the gas discharge tube (13) with an interference, delimiting a number of hermetic chambers of confined spaces isolated one from another.
